(19) United States
(12) Patent Application Publication
(10) Pub. No.: US 2020/0353853 A1
(43) Pub. Date: Nov. 12, 2020

(54) Locking Device for a Rotatable Component

(71) Applicant: Rollax GmbH & Co. KG, Bad Salzuflen (DE)

(72) Inventors: Michael Kuhlmann, Bielefeld (DE); Michael Geis, Werther (DE)

(21) Appl. No.: 16/965,693

(22) PCT Filed: Jan. 23, 2019
(86) PCT No.: PCT/EP2019/051623

§ 371 Date: Jul. 29, 2020

(30) Foreign Application Priority Data
Feb. 7, 2018 (DE) 20 2018 100 651.7

(51) Int. Cl. B60N 2/75; B60N 2/90

(52) U.S. Cl. CPC B60N 2/767; F16D 41/086; B60N 2/938

(57) ABSTRACT

A locking device for a component rotatably mounted on a bearing block, includes a lock mechanism for locking the component in different angular positions, and a switching mechanism for switching the lock mechanism between locking and release positions, the lock mechanism being a clamping lock mechanism including inner and outer rings, one held stationary on the bearing block and the other rotatably connected to the rotatable component with an annular gap therebetween, pairs of clamping bodies in the annular gap, a clamping contour on one ring and delimiting the gap, the clamping bodies and clamping contour being mirror-symmetrical, elastic spreading members between clamping bodies of each pair and prestress the clamping bodies into a clamping position, and a release element including release fingers which, in the release position, engage into intermediate spaces between pairs of clamping bodies and is rotatable together with the ring with the clamping contour.

The invention relates to a locking device for a component that is rotatably mounted on a bearing block, the device comprising a lock mechanism for locking the component in different angular positions, and a manually actuated or motor-actuated switching mechanism for switching the lock mechanism between a locking position and a release position.

More particularly, the invention relates to a locking device for an arm rest at a vehicle seat, the arm rest being adjustable in inclination.

For arm rests at vehicle seats, locking devices have become known which have a pawl lock that permits to lock the arm rest in step-wise adjustable angular positions.

It is an object of the invention to provide a locking device which can easily and safely lock a rotatable component in continuously adjustable angular positions.

In order to achieve this object, according to the invention, the lock mechanism is a clamping lock mechanism comprising:
an inner ring and an outer ring, one of which is held stationary on the bearing block and the other of which is rotatably connected to the rotatable component and which together form an annular gap,
a plurality of pairs of clamping bodies which are arranged in the annular gap,
a clamping contour which is formed on one of the rings and delimits the annular gap, wherein the arrangement of the clamping bodies and the shape of the clamping contour are mirror-symmetrical with respect to a plurality of axes of symmetry extending at uniform angular spacings,
a plurality of elastic spreading members which are arranged between the clamping bodies of each pair and prestress the clamping bodies into a clamping position in the annular gap, and
a release element which, at least in the release position, engages with release fingers into the intermediate spaces between the pairs of clamping bodies and is rotatable together with the ring that forms the clamping contour.

In the locking position, the release element is disabled. When, in this position, a torque acts upon the rotatable component, one of the clamping bodies of each pair is respectively brought into a clamping position, regardless of the direction of rotation, so that a rotation of the inner and outer rings relative to one another and, therewith, a rotation of the component relative to the bearing block is inhibited. However, when the switching mechanism is actuated, the locking device is switched into the release position. Then, when a torque acts upon the rotatable component, at first, the release element is entrained in the respective direction of rotation, and the release fingers press onto the clamping bodies, thereby to prevent them from reaching the clamping position. The rotatable component can be rotated relative to the bearing block together with the release element until the clamping lock mechanism is switched back into the locking position in any arbitrary infinitely variable position.

Useful details and further developments are indicated in the dependent claims.

The rotatable component may be provided with a remote control mechanism by which a key that is disposed remote from the clamping lock mechanism is connected to the switching mechanism of the clamping lock mechanism so that the switching of the clamping lock mechanism can be triggered by actuating the key. The remote control mechanism may for example comprise a Bowden cable. In that case, the distance between the key of the remote control mechanism and the clamping lock mechanism may be variable. Thus, in case of an arm rest, the key may be provided on a part of the arm rest that is telescopically extensible, and the key may be connected to the clamping lock mechanism by the flexible Bowden cable. In an alternative embodiment, the remote control mechanism may also comprise a flexible shaft on which, at the end that is associated with the switching mechanism of the clamping lock mechanism, an excentric is provided by which the rotation of the shaft is translated into a spreading movement that drives the switching mechanism.

Embodiment examples will now be described in conjunction with the drawings, wherein:

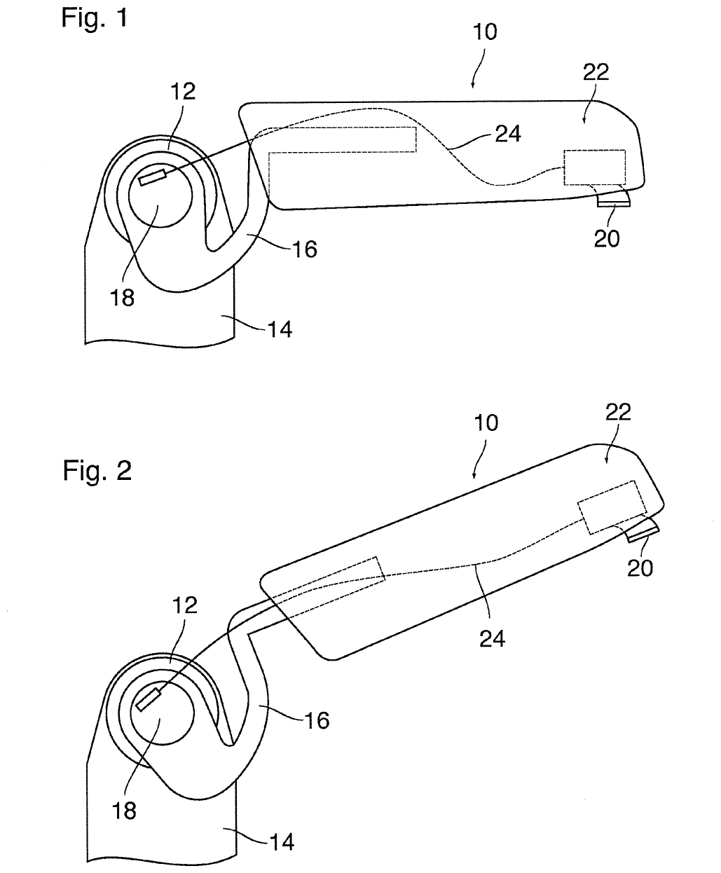

FIG. 1 is a view of an inclination-controllable arm rest having a locking device according to the invention;

FIG. 2 shows the arm rest of FIG. 1 in another adjustment position;

FIG. 3 is a schematic plan view of a clamping lock mechanism;

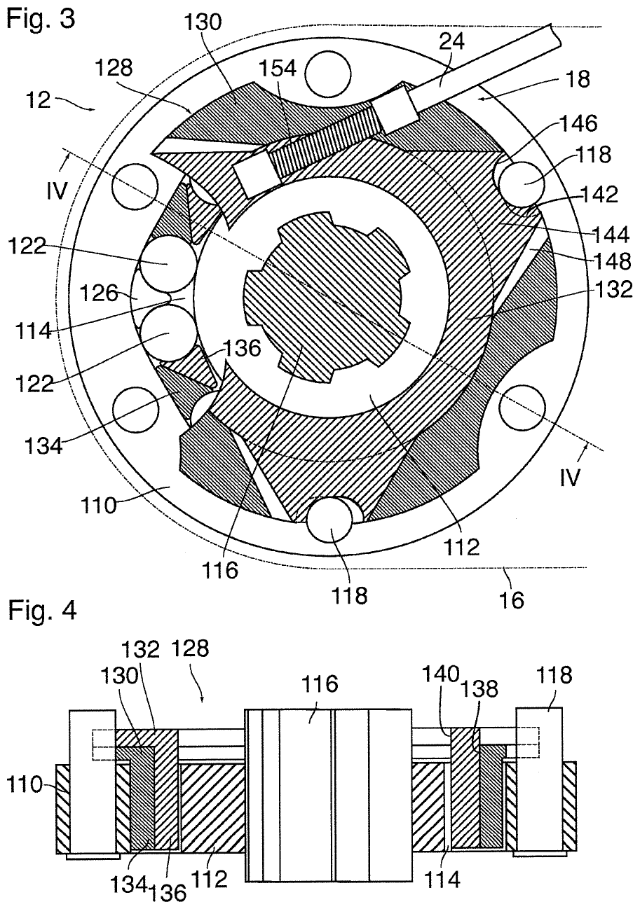

FIG. 4 is a sectional view taken along the line IV-IV in FIG. 3;

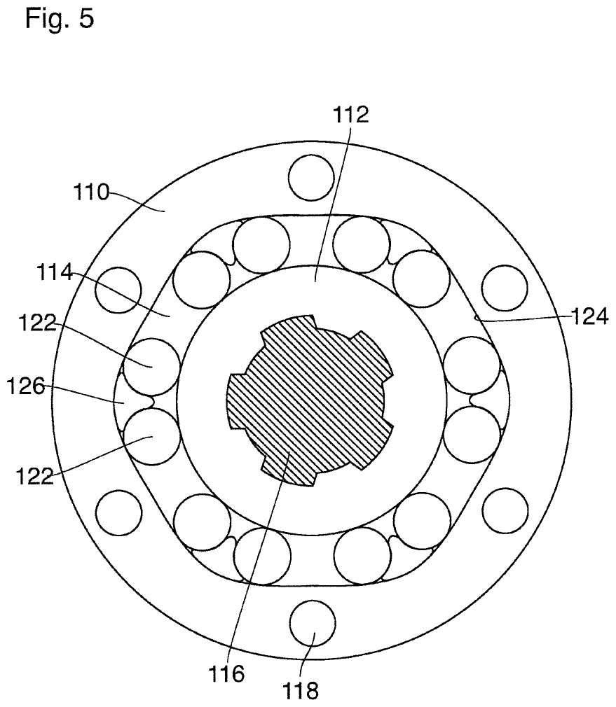

FIG. 5 is a plan view of parts of the clamping lock mechanism;

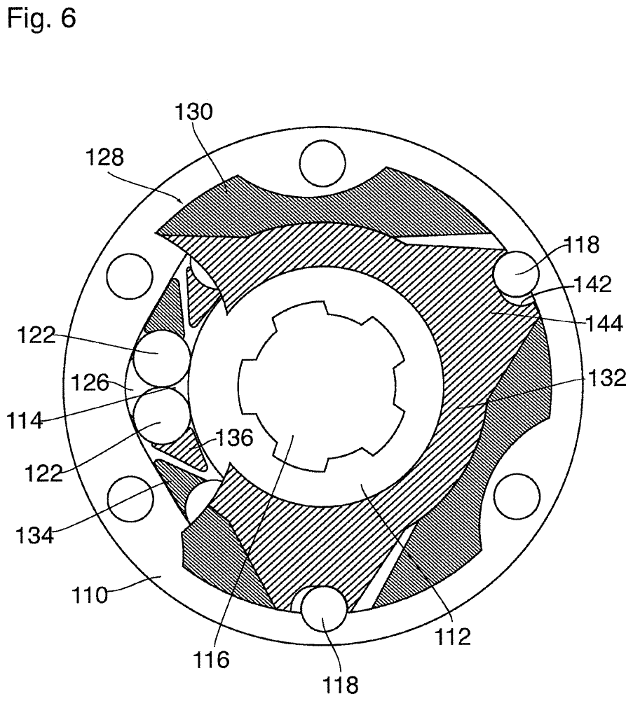

FIG. 6 shows the clamping lock mechanism of FIG. 3 in its release position;

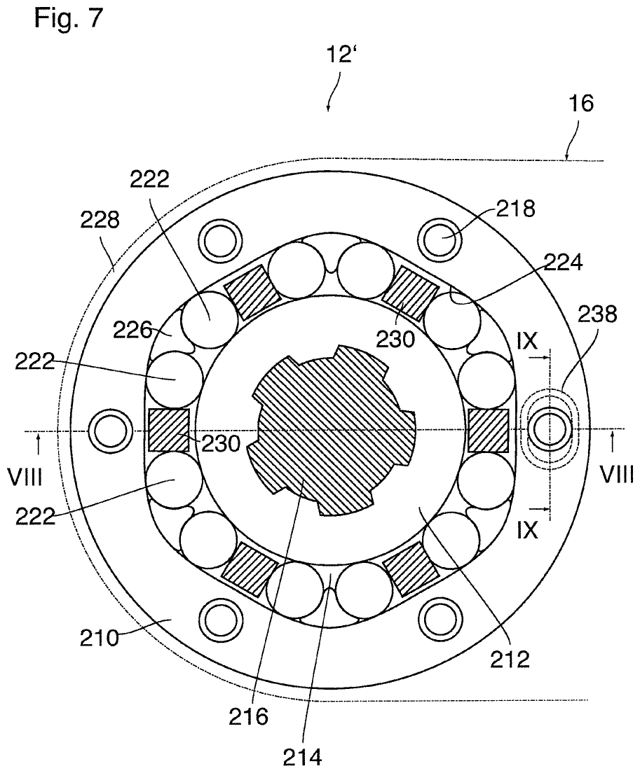

FIG. 7 is a schematic plan view of parts of a clamping lock mechanism according to another embodiment;

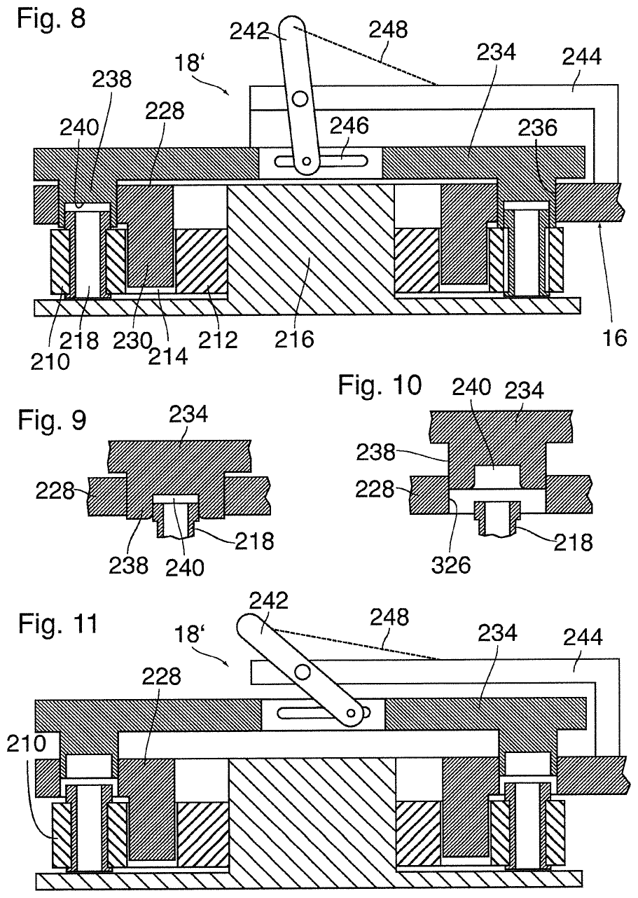

FIG. 8 is a sectional view of the entire clamping lock mechanism; taken along the line VIII-VIII in FIG. 7;

FIGS. 9 and 10 are sectional views taken along the line IX-IX in FIG. 7, for different switching states;

FIG. 11 shows the same cross-section as FIG. 8, but for the switching state according to FIG. 10;

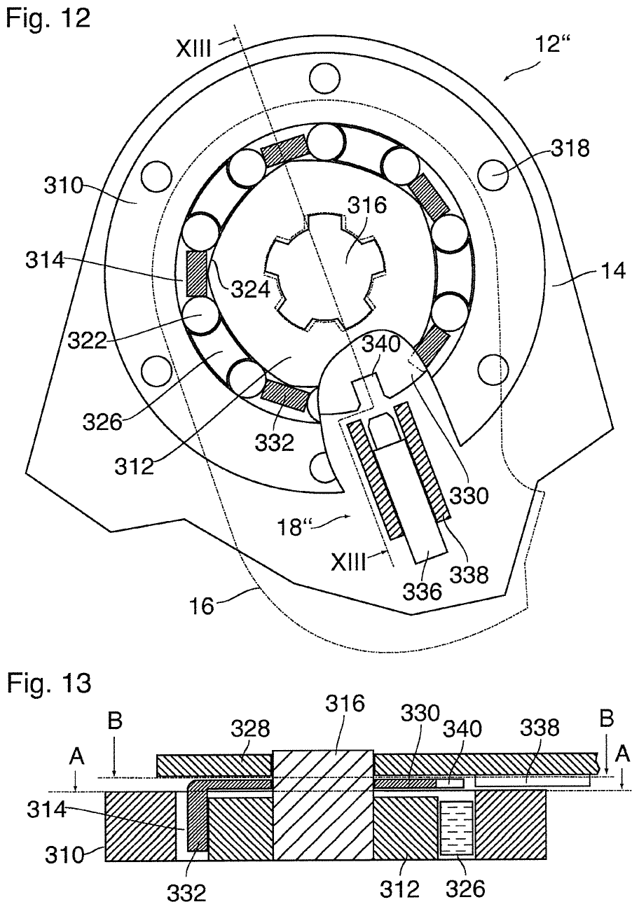

FIG. 12 is a schematic plan view of a clamping lock mechanism according to yet another embodiment;

FIG. 13 is a sectional view taken along the line XIII-XIII in FIG. 12; and

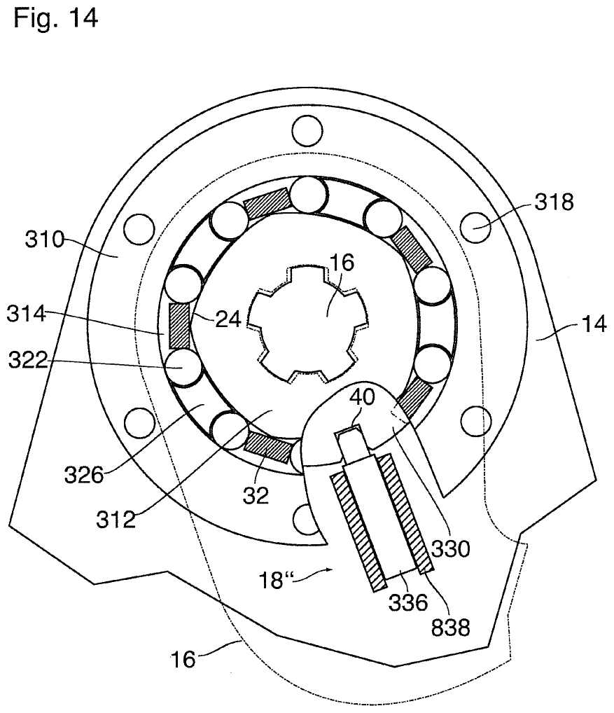

FIG. 14 shows the clamping lock mechanism of FIG. 12 in a release position.

FIG. 1 shows an example of an arm rest 10, e.g. for a vehicle seat, that is supported on a bearing block 14 so as to be continuously adjustable by means of a clamping lock mechanism 12. The clamping lock mechanism 12 couples the bearing block 14 to a rotatable component 16 that takes the form of a rocker on which the proper arm rest 10 is mounted so as to be telescopically extensible.

The clamping lock mechanism 12 has a switching mechanism 18 by which it can be switched between a locking position and a release position. Disposed on the distal end of the arm rest 10 is key 20 that is connected to the switching mechanism 18 by a remote control mechanism 22. In the example shown, the remote control mechanism comprises a Bowden cable 24.

When the user wants to change the inclination of the arm rest 10, she grips with her fingers around the front end of the arm rest and pulls the key 20 upwards. The actuating force is transmitted via the Bowden cable 24 to the switching mechanism 18 which thereupon switches the clamping lock mechanism 12 into the release position, so that the component 16 can freely be rotated relative to the bearing block 14 until the key 20 is released again. Upon release of the key 20, the clamping lock mechanism 12 is switched back into the locking position, so that the component 16 is clampingly held in the angular position that has been reached at that time, and the arm rest is locked in that new position.

FIG. 2 shows the arm rest 10 in an adjustment position in which the inclination relative to the position shown in FIG. 1 has been changed. Moreover, the arm rest 10 has been extended further relative to the component 16 in FIG. 2. The resulting change in the distance between the key 20 and the switching mechanism 18 is compensated by the flexible Bowden cable 24.

A first embodiment example of the clamping lock mechanism 12 will now be explained in conjunction with FIGS. 3 to 6.

The clamping lock mechanism 12 shown in FIG. 3 has an outer ring 110 and an inner ring 112 which are arranged coaxially to one another and essentially in a common plane and, together, form an annular gap 114. The inner ring 112 is keyed onto a shaft 116 that is rigidly held on the bearing block 14. The outer ring 110 has been fastened to the component 16 (only shown in phantom lines) by any known means such as rivets or pins 118 distributed on its periphery, the component 16 being rotatably supported on the shaft 116 by means of the clamping lock mechanism 12 and optionally by means of additional bearings.

As can be seen more clearly in FIG. 5, the annular gap 114 accommodates six pairs of clamping bodies 122 (rollers or balls) that are in sliding engagement with the outer peripheral surface of the inner ring 112 and with the inner peripheral surface of the outer ring 110. Whereas the inner ring 112 has a cylindrical outer periphery, the inner periphery of the outer ring 110 constitutes a non-circular clamping contour 124 which, in the example shown, takes the form of a regular hexagon with the corners slightly rounded off. The clamping contour 124 thus has six axes of symmetry intersecting each other in the center of the clamping lock mechanism at angles of 60°. The clamping bodies 122 of each pair are respectively arranged mirror-symmetrically with respect to these axes of symmetry, and in each corner of the hexagon, an elastic spreading member 126 is arranged between the clamping bodies 122 for urging the two clamping bodies apart and into tapering zones of the annular gap 114. When, now, a torque acts onto the component 116 and, therewith, onto the outer ring 110, the six sides of the hexagonal clamping contour 124 respectively run onto one of the two clamping bodies 122 of each pair, whereby this clamping body is brought into a clamping position and blocks a relative rotation of the rings 110, 112 irrespective of the direction of rotation. In this way, the component 16 is clampingly held in the angular position to which it has been adjusted.

As has been shown in FIGS. 3 and 4, the clamping lock mechanism has a release element 128 that is constituted by an inner disk 130 disposed adjacent to the rings 110, 112, and a disk 132 that is disposed further outwards. The inner disk 130 has six projecting release fingers 134 that engage into the annular gap 114 and respectively engage the one of the clamping bodies 122 that is located in clockwise direction in FIG. 3. The outer disk 132 also has six release fingers 136 that extend inwardly through a central bore 138 of the inner disk 130 into the annular gap 114 and respectively engage the one of the clamping bodies 122 of each pair that is located in counter-clock direction in FIG. 3.

On the left side in FIG. 3, a part of the two disks 130, 132 has respectively been broken away, so that two of the release fingers 134, 136 can be seen in cross-section. In the example shown, the release fingers are wedge-shaped in cross-section, so that they form a large engagement surface for the respective clamping body 122.

The outer disk 132 has a central bore 140 that is penetrated by the shaft 116, and it has, at its inner peripheral edge, a hub with which it is rotatably supported in the bore 138 of the inner disk 130. The outer peripheral edge of the inner disk 130 reaches up to the circle of pins 118 but has, at the position of three of these pins, a respective recess 142 that extends in circumferential direction (hidden in FIG. 3 and shown only in phantom lines) which encloses the respective pin 118. By these three pins 118, the disk 130 is centered onto the outer ring 110, and that the same time the possible angle of rotation of the disk 130 relative to the ring 110 is limited (to approximately 3° in the example shown). At the positions of the other three pins 118 the disk 130 forms larger recesses, so that these pins do not restrict the movement of the disk 130.

The outer disk 132 has three radially projecting arms 144 each of which has at its free end a recess 146 that corresponds to the recess 142, so that the angle of rotation of the disk 132 relative to the ring 110 is also restricted. This also restricts the possible angle of rotation of the two disks 130, 132 relative to one another.

Each of the arms 144 of the outer disk 132 is accommodated in a shallow recess 148 of the inner disk 130, so that the outer surfaces of the two disks 130, 132 are flush with one another.

The switching mechanism 18 serves for rotating the two disks 130, 132 of the release element 128 relative to one another. In the example shown, in order to form the switching mechanism, an outer sheath of the Bowden cable 24 is fixed at the inner disk 130, and an inner wire of the Bowden cable is fixed at the outer disk 132. Disposed between the fixing points of the outer sheath and the inner wire is a compression spring 154 that urges the two disks 130, 132 into the relative angular position shown in FIG. 3. This angular position is a locking position of the release element 128, in which the release fingers 134, 136 leave so much play for the clamping bodies 122 in circumferential direction of the annular gap 114 that they are held in their clamping position by the spreading members 126. If the component 16 and the outer ring 110 would be rotated relative to the inner ring 112, then, irrespective of the direction of rotation, one of the two clamping bodies 122 of each pair would enter into an even narrower part of the annular gap 114, so that the clamp action would become even stronger. In this way, the component 16 is self-lockingly blocked in both directions of rotation.

If, however, the Bowden cable 124 is actuated and the compression spring 154 is compressed thereby, then the two disks 130, 132 are rotated into a release position as shown in FIG. 6, so that they are brought into the opposite terminal position relative to the pins 118. In this position, the clamping bodies 122 of each pair are forced out of their clamping position while compressing the spreading member 126, so that the clamp action is cancelled. When the ring 110 is rotated into any direction, the pins 118 assure that the release member 128 is entrained in the direction of rotation and continues to keep the clamping bodies 122 away from the clamping position until the Bowden cable 24 is released and the two disks of the release element return to the position shown in FIG. 3.

If a torque, e.g. in clockwise direction in FIG. 3, acts upon the ring 110 even before the switching mechanism is actuated, then it is possible that the clamping bodies 122 of each pair that are trailing in the clockwise direction are clamped so strongly that they cannot be forced out of the clamping position by the release fingers 136 and, consequently, only the inner disk 130 but not the outer disk 132 is moved when the Bowden cable 24 is actuated. However, as soon as the inner disk 130 has reached its terminal position that is defined by the pins 118, it cannot rotate further, so that the entire force of the Bowden cable acts upon the release fingers 136 and overcomes the clamping force, so that the clamp action is cancelled even under these conditions.

The embodiment example that has been described above can be modified in various ways.

At first, it will be understood that it is not essential for the function of the clamping lock mechanism whether the shaft 16 and the inner ring 112 are stationary and the component 16 and the outer ring 110 are rotatable or vice versa. It is only essential that the disks 130, 132 of the release element are coupled, though with a certain play, to the ring 110 that forms the clamping contour 124.

In another embodiment, however, the clamping contour could be formed on the inner ring 112 rather than the outer ring 110. In that case, the disks of the release element would be coupled with the inner ring 112 such that they could be rotated only by a restricted angle relative to the inner ring 112.

FIG. 7 shows a clamping lock mechanism 12′ according to another embodiment. This clamping lock mechanism has an outer ring 210 and an inner ring 212 that are arranged adjacent to one another and essentially in a common plane and, together, form an annular gap 214. The inner ring 212 is keyed onto a shaft 216. The outer ring 210 is attached to the component 16 by means of rivets 218 distributed on the periphery, the components 16 being supported rotatably on the shaft 216 by means of the clamping lock mechanism and optionally by means of additional bearings. If the ring 210 is formed by a packet of stacked lamella, as is known per se, the rearwards 118 may also serve for holding the packet of lamella together.

The annular gap 214 accommodates six pairs of clamping bodies 222 (rollers or balls) that are in sliding engagement with the outer peripheral surface of the inner ring 212 and with the inner peripheral surface of the outer ring 210. Whereas the inner ring 212 has a cylindrical outer periphery, the inner periphery of the outer ring 210 constitutes a non-circular clamping contour 224 which, in the example shown, takes the form of a regular hexagon with the corners slightly rounded off. The clamping contour 224 thus has six axes of symmetry intersecting each other in the center of the clamping lock mechanism at angles of 60°. The clamping bodies 222 of each pair are respectively arranged mirror-symmetrically with respect to these axes of symmetry, and in each corner of the hexagon, an elastic spreading member 226 is arranged between the clamping bodies 222 for urging the two clamping bodies apart and into tapering zones of the annular gap 214. When, now, a torque acts onto the component 16 and, therewith, onto the outer ring 210, the six sides of the hexagonal clamping contour 224 respectively run onto one of the two clamping bodies 222 of each pair, whereby this clamping body is brought into a clamping position and blocks a relative rotation of the rings 210, 212 irrespective of the direction of rotation. In this way, the component 16 is clampingly held in the angular position to which it has been adjusted.

The clamping lock mechanism has a release element 228 that has only been shown incompletely in FIG. 7 and that has six release fingers 230 engaging into the interstices between the pairs of clamping bodies 222. The release fingers 230 have been shown in cross-section in FIG. 7.

As has been shown in FIG. 8, the release element 228 is formed by an end of the rotatable component 16 in this example. The sectional plane in FIG. 8 passes through two of the release fingers 230 that engage into the annular gap 214 and through two of the rivets 218.

Just as the switching mechanism 18 in FIG. 1, a switching mechanism 18′ serves for releasing the clamping lock mechanism and comprises a disk-shaped coupling member 234 that engages the release element 228 on the outer side and has several plug-like projections 238 passing through respective openings 236 that are distributed on the periphery of the release element. Each of the projections 238 has at its free end a recess 240 into which a head of one of the rivets 218 engages in the condition shown in FIG. 8. The projections 238 are axially displaceable in the openings 236 of the release element 228, but are guided in these openings without play. Thus, in the condition shown in FIG. 8, the rotatable component 16 is locked non-rotatably to the outer ring 210 of the clamping lock mechanism and to the bearing block 14 via the release element 228, the projections 238 of the coupling member 234, and the rivets 218.

In FIG. 7, the contour of one of the projections 238 has been shown in phantom lines. It can be seen that this projection has an elongated shape in circumferential direction of the ring 210. The internal cross-section of the openings 236 in the release element has a like elongated shape.

In FIG. 9, one of the projections 238 has been shown in a longitudinal section. It can be seen here that the recess 240 has a circular cross-section and tightly encloses the head of the rivet 218, whereby the release element 238 is non-rotatably coupled to the ring 210.

When, however, the coupling member 234 is lifted into the position shown in FIG. 10, the recesses 240 release the heads of the rivets 218, so that these rivets can move in the elongated openings 236 and thereby allow for a limited rotation of the release element 228 relative to the ring 210. However, the projections 238 of the coupling member 234 remain in engagement with the top ends of the openings 236, so that the coupling member continues to be non-rotatably locked to the release element 228 and the component 16.

If, now, a torque acts upon the component 16 while the coupling member 234 is in the position shown in FIG. 10, then the release element 238 is rotated relative to the ring 210 within the range of play that is limited by the rivets 218, so that the release fingers 230 (FIG. 7) respectively press on the clamp rollers that are leading in the direction in which the torque acts. These clamp rollers are therefore forced out of their clamping position with slight compression of the elastic spreading members 226, so that, when the component 16 and the coupling member 234 are rotated further, the ring 210 is entrained in rotary direction by the rivets 218.

As soon as the torque is cancelled in the position that the component 16 has reached, the elastic restoring forces of the spreading members 226 assure that the release fingers 230 and the recesses 240 in the projections 238 are re-aligned in circumferential direction with the rivets 218, so that the coupling member 234 can again be pressed closer against the release element 228 and, consequently, the projections 238 come again into engagement with the heads of the rivets 218, and the locked position as shown in FIGS. 7 and 8 is restored. Optionally, the recesses 240 can have a slight chamfer facilitating the entry of the rivet heads into the recesses.

As can be seen in FIG. 8, the switching mechanism 18′ comprises a lever 242 which serves for toggling the coupling member 234 between the locking position shown in FIGS. 8 and 9 and a release position shown in FIGS. 10 and 11. The lever 242 is rotatably supported on a bracket 244 that is rigidly connected to the component 16. Its lower end in FIG. 8 is in engagement with the coupling member 234 via an elongated hole 246 that is formed in an opening of the coupling member. The top end of the lever 242 in FIG. 8 is subject to the force of a tension spring 248 that biases the lever in clock sense, so that the coupling member 234 is jammed into the position shown in FIG. 8.

However, the lever 242 can be pivoted in counter-clock sense against the force of the tension spring 248 by the remote control mechanism 22, whereby the coupling member 234 is drawn into the release position shown in FIG. 11.

Since the component 16 is not rotated relative to the coupling member 234 and the release member 228 in this embodiment, the remote control mechanism 22 may also be rigid, e.g. in the form of a rigid actuating rod.

In the embodiment shown here, the clamping contour 224 is formed on the outer ring 210, and the release element 228 is adapted to be coupled to the ring 210. In another embodiment, however, the clamping contour could also be formed on the inner ring 212 rather than on the outer ring 210. In that case, the release element would be adapted to be coupled to the inner ring 212.

FIG. 12 shows a clamping lock mechanism 12″ according to yet another embodiment. This clamping lock mechanism has an outer ring 310 and an inner ring 312 which are arranged coaxially to one another and essentially in a common plane and, together, form an annular gap 314. The inner ring 312 is keyed onto a shaft 316. The outer ring 310 has been fastened to the bearing block 14 by any known means such as rivets or pins 318 distributed on its periphery.

The annular gap 314 accommodates five pairs of clamping bodies 322 (rollers or balls) that are in sliding engagement with the outer peripheral surface of the inner ring 312 and with the inner peripheral surface of the outer ring 310. Whereas the outer ring 312 has a cylindrical inner periphery, the outer periphery of the inner ring 310 constitutes a non-circular clamping contour 324 which, in the example shown, takes the form of a regular pentagon with the corners slightly rounded off. The clamping contour 324 thus has five axes of symmetry intersecting each other in the center of the clamping lock mechanism at angles of 72°. The clamping bodies 322 of each pair are respectively arranged mirror-symmetrically with respect to these axes of symmetry, and in each corner of the pentagon, an elastic spreading member 326 is arranged between the clamping bodies 322 for urging the two clamping bodies apart and into tapering zones of the annular gap 314.

The component 16 is keyed onto an end of the shaft 316 that projects from the ring 312 such that it can be rotated in a restricted angular range relative to the shaft and, beyond that, can be rotated only jointly with the shaft 316. The component 16 is rotatably supported on the bearing block 14 by means of the clamping lock mechanism and optionally by means of additional bearings.

When, now, a torque acts upon the component 16 and, therewith, upon the inner ring 312, the five sides of the clamping contour 324 run respectively onto one of the two clamping bodies 322 of each pair, whereby this clamping body is brought into a clamping position and locks the rings 310, 312 against relative rotation, irrespective of the direction of rotation. In this way, the component 16 is clampingly held in the position to which it has been adjusted.

The clamping lock mechanism further has a disk-shaped release element 330 that is disposed in a plane offset from the rings 310, 312 and has release fingers 332 engaging into the interstices between the pairs of clamping bodies 322. In FIG. 12, the release fingers 332 have been shown in cross-section (sectional plane corresponding to the line A-A in FIG. 13) and only in a part of FIG. 12 the sectional plane has been shifted (line B-B in FIG. 13), such that the part of the disk of the release element 33 is also visible. Just as the component 16, the release element 330 is keyed onto the shaft 316 such that it can only be rotated relative to the shaft 316 and the ring 312 within a restricted angular range.

FIG. 12 and also the sectional view in FIG. 13 show the clamping lock mechanism in a locking position in which the release element 330 is uncoupled from the component 16. However, the clamping lock mechanism also has a switching mechanism 18″ by which the release element 330 can be non-rotatably coupled to the component 16 in order to switch the clamping lock mechanism into a release position. In the example shown, the switching mechanism 18″ comprises a latch 336 that is slidable in radial direction in a guide 338 formed on the bottom side of the component 16 and opposing a catch 340 in the edge of the release element 330.

When the clamping lock mechanism is to be switched into the release position, the remote control mechanism 22 is used for moving the latch 336 radially inwards, such that its head enters into the catch 340. In this way, the release element 330 is rigidly locked to the component 16. If, in this condition, a torque acts upon the component 16, this component can rotate relative to the shaft 316 and the inner ring 312 in the restricted angular range but entrains the release element 330, so that the release fingers 332 thereof press respectively on one of the clamping bodies 322 of each pair and keep this clamping body away from the clamping position. The clamp action thus being cancelled, the inner ring 312 can rotate together with the clamping bodies and the release element, so that the component 16 can continuously be adjusted into the desired angular position. When no torque acts upon the component 16 any longer, the elastic spreading members 326 assure that the clamping bodies 322 are urged back into the clamping position, whereby the release element 330 is held in the angular position in which the catch 340 remains aligned with the latch 336. Then, the latch 336 can be withdrawn from the catch 340 in order to lock the component 316 again, and it can smoothly be inserted into the catch 340 again, if a new angular adjustment of the component 16 is desired.

The latch 336 may also be biased elastically into its radially outward terminal position so that, when the actuating mechanism is released, it retreats automatically from the catch 340 and holds the clamping lock mechanism in the locking position.

The embodiment described above can be modified in various ways.

For example, the release element 330 may have, in place of the single catch 340 at its peripheral edge, a plurality of catches or a toothed rim into which a suitably adapted latch may engage. The latch may also be formed at an end of a pivotable pawl.

While the clamping contour 324 is formed on the inner ring 312 in the example shown, other embodiments are possible in which the clamping contour is formed on the outer ring 310. In that case, the component 16 and the release element 330 would be coupled to the outer ring 310 and would be rotatable relative to this ring only in a restricted angular range, whereas the inner ring 312 would be held rigidly on the bearing block 14.

What is claimed is:

1. A locking device for a component that is rotatably mounted on a bearing block, the device comprising:
a lock mechanism for locking the component in different angular positions, and
one of a manually actuated or motor-actuated switching mechanism for switching the lock mechanism between a locking position and a release position,
wherein the lock mechanism is a clamping lock mechanism comprising:
an inner ring and an outer ring, one of which is held stationary on the bearing block and the other of which is rotatably connected to the rotatable component and which together form an annular gap therebetween,
a plurality of pairs of clamping bodies which are arranged in the annular gap,
a clamping contour formed on one of the rings and which delimits the annular gap, wherein the arrangement of the clamping bodies and the shape of the clamping contour are mirror-symmetrical with respect to a plurality of axes of symmetry extending at uniform angular spacings,
a plurality of elastic spreading members which are arranged between the clamping bodies of each pair and prestress the clamping bodies into a clamping position in the annular gap, and
a release element including release fingers which, at least in the release position, engage into intermediate spaces between the pairs of clamping bodies and is rotatable together with the ring that forms the clamping contour.

2. The locking device according to claim 1, wherein the release element comprises two disks which both engage into the intermediate spaces between the pairs of clamping bodies with a respective said release finger and which are rotatable relative to one another between the locking position and the release position.

3. The locking device according to claim 1, wherein the release element is rigidly connected to the rotatable component and the switching mechanism is configured for:
coupling, in the locking position, a release element non-rotatably to the ring that comprises the clamping contour and
allowing, in the release position, a limited rotation of the release element relative to the ring.

4. The locking device according to claim 1, wherein the rotatable component is rotatable relative to the ring that forms the clamping contour within a restricted annular range, and the switching mechanism is configured for:
coupling, in the release position, the release element non-rotatably to the rotatable component and
allowing, in the locking position, a rotation of the release element relative to the rotatable component.

5. The locking device according to claim 1, comprising a remote control mechanism for actuating the switching mechanism.

6. The locking device according to claim 5, wherein the remote control mechanism comprises a flexible member.

7. The locking device according to claim 6, wherein the remote control mechanism that connects the switching mechanism to an actuating member is mounted on a member that is held on the rotatable component in a telescopically extensible manner.

8. An adjustable arm rest for vehicle seats, comprising a locking device according to claim 1.

9. The locking device according to claim 6, wherein the flexible member comprises a Bowden cable.
